(19) United States
(12) Patent Application Publication
(10) Pub. No.: US 2012/0124481 A1
(43) Pub. Date: May 17, 2012

(54) INTERACTING WITH A DEVICE

(76) Inventor: Robert Campbell, Cupertino, CA (US)

(21) Appl. No.: 13/387,112

(22) PCT Filed: Mar. 18, 2010
(86) PCT No.: PCT/US10/27830

§ 371 Date: Jan. 25, 2012

(51) Int. Cl. G06F 3/01; G06F 15/16

(52) U.S. Cl. 715/748

(57) ABSTRACT

A method for communicating with a device including configuring a sensor to detect the device and a user interacting with the device through at least one gesture, identifying the device with a computing machine, and initiating a file transfer between the device and the computing machine in response to identifying the device and at least one of the gesture.

### BACKGROUND

When configuring a computing machine to communicate with a device, a user can configure the computing machine to recognize and access the device using one or more input devices on the computing machine. Additionally, the user can access one or more input devices of the device when configuring the device to recognize and access the computing machine. Once the computing machine and/or the device are configured, the user can additionally utilize one or more of the input devices of the computing machine or of the device to initiate a communication between the computing machine and the device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates a computing machine with a processor, a sensor, a storage device, and a device application according to an embodiment of the invention,

FIG. 2 illustrates a sensor coupled to a computing machine detecting a device according to an embodiment of the invention.

FIG. 3 illustrates a block diagram of a device application identifying a device according to an embodiment of the invention.

FIG. 4A illustrates a content of interest being identified and a user interacting with a device through at least one gesture according to an embodiment of the invention.

FIG. 4B illustrates a content of interest being identified and a user interacting with a device through at least one gesture according to another embodiment of the invention.

FIG. 4C illustrates a content of interest being identified and a user interacting with a device through at least one gesture according to other embodiments of the invention.

FIG. 5 illustrates a block diagram of a device application initiating a communication between a computing machine and a device according to an embodiment of the invention.

FIG. 6 illustrates a computing machine with an embedded device application and a device application stored on a storage medium being accessed by the computing machine according to an embodiment of the invention.

FIG. 7 is a flow chart illustrating a method for communicating with a device according to an embodiment of the invention.

FIG. 8 is a flow chart illustrating a method for communicating with a device according to another embodiment of the invention.

### DETAILED DESCRIPTION

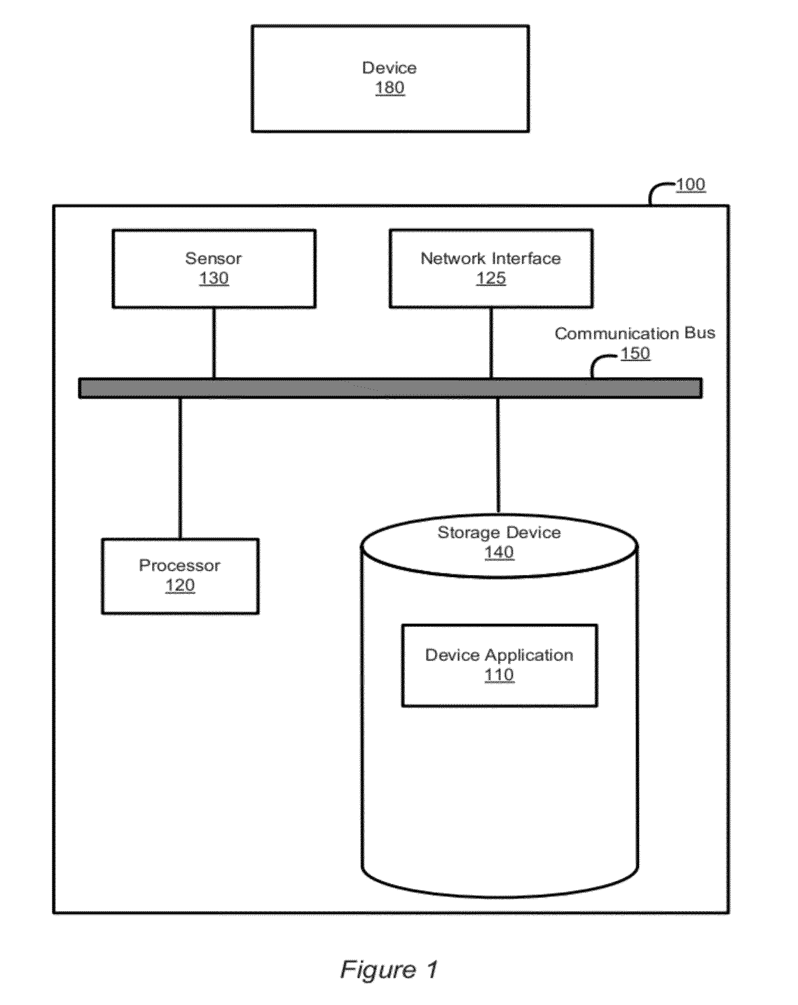

FIG. 1 illustrates a computing machine 100 with a processor 120, a sensor 130, a storage device 140, and a device application 110 according to an embodiment of the invention. In one embodiment, the computing machine 100 is a desktop, laptop/notebook, netbook, and/or any other computing device the sensor 130 can be coupled to. As illustrated in FIG. 1, the computing machine 100 is coupled to a processor 120, a sensor 130, a storage device 140, a display device 170, a network interface 125, and a communication bus 150 for the computing machine 100 and/or one or more components of the computing machine 100 to communicate with one another.

Further, as shown in FIG. 1, the storage device 140 can store a device application 110. In other embodiments, the computing machine 100 includes additional components and/or is coupled to additional components in addition to and/or in lieu of those noted above and as illustrated in FIG. 1.

As noted above, the computing machine 100 includes a processor 120. The processor 120 sends data and/or instructions to one or more components of the computing machine 100, such as the sensor 130 and/or the device application 110. Additionally, the processor 120 receives data and/or instruction from one or more components of the computing machine 100, such as the sensor 130 and/or the device application 110.

The device application 110 is an application which can be utilized in conjunction with the processor 120 and at least one sensor 130 to detect a device 180 or an object identified to be a device 180. The device application 110 can further configure the sensor to capture a user interacting with the device 180 or the object through at least one gesture.

For the purposes of this application, a device 180 can be any component, peripheral, and/or computing machine which can communicate with the computing machine 100 and/or another device by sending and/or receiving one or more files. Additionally, an object can include any passive object identified by the device application 110 to be a device 180 coupled to the computing machine 100. A user can be any person which can physically interact with the device 180, any object identified to be the device 180, the computing machine 100, and/or another device through one or more gestures.

A gesture can include one or more visual motions, audio or speech, and/or touch motions made by the user. The gesture can be made by the user to or from the device 180, an object, the computing machine 100, or another device coupled to the computing machine 100. The visual motion can include one or more hand motions or finger motions. In other embodiments, a gesture can include additional forms of input made by the user in addition to and/or lieu of those noted above.

If a device is detected by the sensor 130, the device application 110 can proceed to identify the device 180. In another embodiment, if an object is detected, the device application 110 will attempt to identify the object as a device. Once the device 180 and/or an object have been identified with the computing machine 100, the device application 110 can proceed to initiate a file transfer between the device 180 and the computing machine 100 and/or another device in response to identifying the device 180 and at least one of the gestures captured by the sensor 130.

In one embodiment, when initiating a file transfer, the processor 120 can send one or more instructions to the device application 110 to send and/or receive one or more files from the device 180, initiate a syncing action with the device 180, initiating a backup action with the device 180, and/or share a configuration setting to or from the device 180. In other embodiments, the device application 110 can send one or more of the instructions to the device 180, the computing machine 100, and/or another device to initiate the file transfer.

The device application 110 can be firmware which is embedded onto the computing machine 100. In other embodiments, the device application 110 is a software application stored on the computing machine 100 within ROM or on the storage device 140 accessible by the computing machine 100 or the device application 110 is stored on a computer readable medium readable and accessible by the computing machine 100 from a different location.

Additionally, in one embodiment, the storage device 140 is included in the computing machine 100. In other embodiments, the storage device 140 is not included in the computing machine 100, but is accessible to the computing machine 100 utilizing a network interface 125 of the computing machine 100. The network interface 125 can be a wired or wireless network interface card.

In a further embodiment, the device application 110 is stored and/or accessed through a server coupled through a local area network or a wide area network. The device application 110 communicates with devices and/or components coupled to the computing machine 100 physically or wirelessly through a communication bus 150 included in or attached to the computing machine 100. In one embodiment the communication bus 150 is a memory bus. In other embodiments, the communication bus 150 is a data bus.

As noted above, the device application 110 can be utilized in conjunction with the processor 120 and at least one sensor 130 to detect a device 180 and capture a user interacting with the device 180 through at least one gesture. As noted above, a device 180 can be any component, peripheral, and/or computing machine which can communicate with the computing machine 100 and/or another device by sending and/or receiving one or more files.

The device 180 can receive and/or send one or more instructions when communicating with the device application 110, the computing machine 100, and/or another device. Further, the device 180 can be configured to communicate with the computing machine 100 and/or another device in response to a user interacting with the device 180 or another object identified to be the device 180 through at least one gesture. Additionally, the device 180 can communicate with the computing machine 100 and/or another device through a physical connection or through a wireless connection.

When communicating with the computing machine 100 and/or another device, the device 180 can be physically coupled to a port or an interface of the computing machine 100. In another embodiment, the device 180 can wirelessly couple to the computing machine 100, a port, or an interface of the computing machine 100 when the device 180 comes within proximity of the computing machine 100.

In one embodiment, the device 180 can be or include a media device, an image capturing device, an input device, an output device, a storage device, and/or a communication device. In other embodiments, the device 180 can be or include additional devices and/or components in addition to and/or in lieu of those noted above.

When detecting the device 180 and/or a user interacting with the device 180, the device application 110 and/or the processor 120 can configure the sensor 130 to scan an environment around the computing machine 100 for the device 180. For the purposes of this application, the environment includes a space and/or volume around the computing machine 100 or around the sensor 130

In another embodiment, if the device 180 and/or another device are not within a view of the sensor 130, the device application 110 can identify and represent one or more objects within a view of the sensor 130 as a device 180 or another device coupled to the computing machine 100. One or more of the objects can include a passive object identified and represented by the device application 110 as the device 180 or another device coupled to the computing machine 100.

A sensor 130 is a detection device or component configured to scan for or to receive information from the environment around the sensor 130 or the computing machine 100. In one embodiment, a sensor 130 is a 3D depth image capturing device configured to scan a volume in front of or around the sensor 130. In another embodiment, the sensor 130 can include at least one from the group consisting of a motion sensor, a proximity sensor, an infrared sensor, a stereo device, and/or any other image capturing device. In other embodiments, a sensor 130 can include additional devices and/or components configured to receive and/or to scan for information from an environment around the sensor 130 or the computing machine 100.

A sensor 130 can be configured by the processor 120 and/or the device application 110 to actively, periodically, and/or upon request scan the environment for the device and/or the user interacting with the device. In another embodiment, the sensor 130 can be configured to scan for an object which can be represented as the device 180 and the user interacting with the object. When configuring the sensor 130, the processor 120 and/or the device application 110 can send one or more instructions for the sensor 130 to scan the environment.

Further, at least one sensor 130 can be coupled to one or more locations on or around the computing machine 100. In another embodiment, at least one sensor 130 can be integrated as part of the computing machine 100. In other embodiments, at least one of the sensors 130 can be coupled to or integrated as part of one or more components of the computing machine 100, such as a display device 170.

Once a device 180 is detected by the sensor 130, the device application 110 will attempt to identify the device 180. When identifying the device 180, the device application 110 and/or the computing machine 100 can attempt to access the device 180 and read one or more files from the device 180. One or more of the files can be a header file configured to list a make, a model, and/or a type of the device 180. In another embodiment, one or more of the files can be a device driver file configured to list the make, the model, and/or the type of the device 180.

In another embodiment, the device application 110 and/or one or more components of the computing machine 100, such as the network interface 125, can be configured to emit and/or detect one or more wireless signals. The wireless signal can be a query to the device 180 for an identification of the device 180. If the device 180 detects the query, the device 180 can then emit one or more signals back to the computing machine 100 to identify the device 180 and authenticate the device 180. One or more of the signals can include an identification key. In one embodiment, the identification key can specify a make, a model, and a type of the device 180.

Utilizing the information read from one or more of the files or signals of the device 180, the device application 110 can proceed to identify the device 180 using the listed make, the model, and/or the type of the device 180. In another embodiment, the device application 110 can access a file, a list, and/or a database of devices. The file, list, and/or database of devices can include one or more entries which list devices which have previously been identified and/or recognized by the device application 110 or the computing machine 100. Further, the devices listed in the file, list, and/or database of devices can include a make, a model, and/or a type of the device 180.

Utilizing one or more of the files or signals from the device 180, the device application can scan the file, list, and/or database of devices for a matching entry. If a match is found, the device application 110 will determine that the device 180 has been identified. Further, the device application 110 will not access the information within one or more of the files or signals. In other embodiments, the device application 110 can utilize additional files, signals, and/or methods when identifying the device 180 in addition to and/or in lieu of those noted above.

In another embodiment, if no match is found, the device application 110 can identify the device 180 with information from one or more of the files and signals. The device application 110 can additionally store information of the device 180 for subsequent identification. The information of the device 180 can be the corresponding file and/or identification key utilized to identify the device 180

In other embodiments, if a device 180 is not captured within a view of the sensor 130, the sensor 130 will be configured to scan for an object. If the object is detected the sensor 130 can capture one or more dimensions of the object for the device application 110 to identify. The device application 110 can compare the captured dimensions to one or more of the dimensions of the device 180 listed in the file, list, and/or database of devices. If the device application 110 determines that one or more of the dimensions match, the object can be identified and represented as the device 180.

Once the device application 110 has identified the device 180, the device application 110 can proceed to configure the device 180 to communicate with the computing machine 100 and/or another device by initiating a file transfer between the device 180 and the computing machine 100 and/or another device in response to identifying the device 180 and the user interacting with the device 180, an object identified to be the device 180, the computing machine 100, and/or another device through at least one gesture.

As noted above, when interacting with the device 180, the computing machine 100, and/or another device, the device application 110 and/or the processor can configure the sensor 130 to detect and capture the user making one or more gestures between the device 180 and the computing machine 100 and/or another device. In another embodiment, the sensor 130 can detect the user interacting with a representative object identified to be the device 180 through one or more gestures. The device application 110 can then correspond any gestures made to or from the representative object, to gestures made to or from the corresponding device 180.

If a gesture is detected from the user, the device application 110 can capture information of the gesture. The sensor 130 can be configured to detect a type of the gesture, a beginning and an end of the gesture, a length of the gesture, a duration of the gesture, and/or a direction of the gesture. Utilizing the captured information from the gesture, the device application 110 can identify whether the file transfer is made between the device 180 and the computing machine 100 and/or another device.

In another embodiment, the device application 110 can utilize the captured information to identify a type of file transfer action. The type of the file transfer action can correspond to whether a file transfer is being transferred from the device 180 or to the device 180. The type of file transfer can include a syncing action and/or a backup action. Further, the device application 110 can utilize the captured information to identify a content of interest when initiating a file transfer.

A content of interest can include one or more files, one or more media, and/or one or more configurations or settings available on the device 180, the computing machine 100 and/or another device. Further, a content of interest can be stored on the device 180, the computing machine 100, and/or another device. In one embodiment, the device application 110 further configures a display device 170 to render the content of interest. The content of interest can be rendered in the form of one or more icons and/or images included in a graphical user interface displayed on the display device 170. Additionally, the user interface can be configured to display the device 180 communicating with the computing machine 100 and/or another device when initiating a file transfer.

A display device 170 is a device that can create and/or project one or more images and/or videos for display. In one embodiment, the display device 170 can be a monitor and/or a television. In another embodiment, the display device 170 is a projector that can project one or more images and/or videos. The display device 170 can include analog and/or digital technology. Additionally, the display device 170 can be coupled to the computing machine 100 or the display device 170 can be integrated as part of the computing machine 100.

Once the device application 110 has identified one or more content of interest and determined whether to initiate the file transfer between the device 180 and the computing machine 100 and/or another device, the device application 110 can send one or more instructions to the device 180, the computing machine 100, and/or another device to initiate a file transfer.

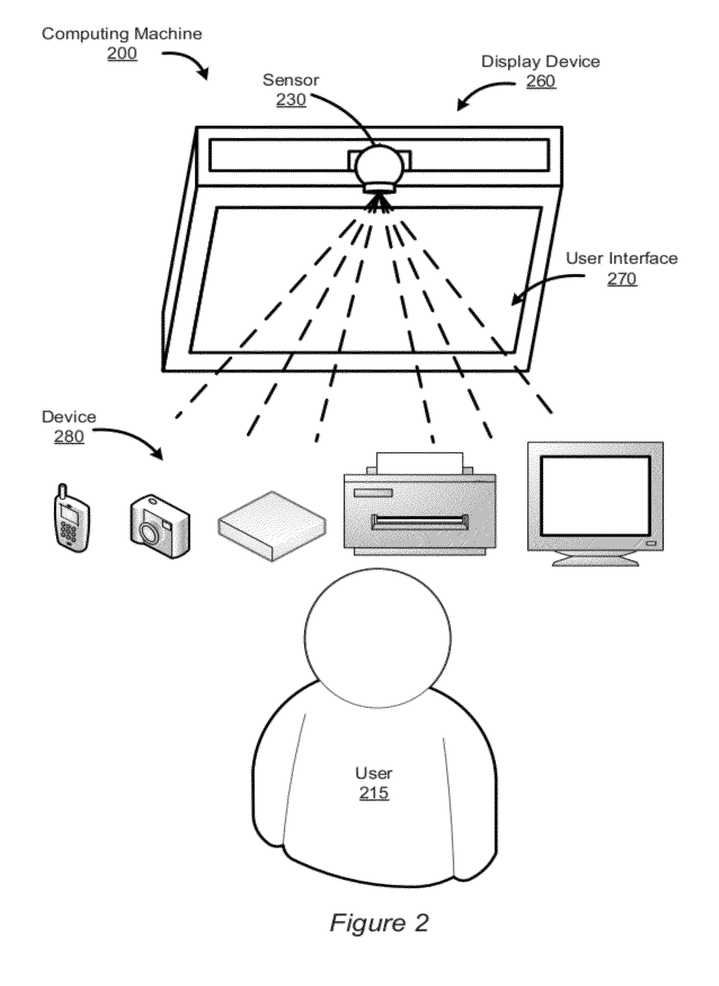

FIG. 2 illustrates a sensor 230 coupled to a computing machine 200 detecting a device 280 according to an embodiment of the invention. In one embodiment, the sensor 230 can be a 3D depth image capture device and the sensor 230 can be coupled to a display device 270 of the computing machine 200. In other embodiments, the sensor 230 can be any additional detection devices and the sensor 230 can be coupled to additional locations or positions around the computing machine 200.

As illustrated in FIG. 2, in one embodiment, the sensor 230 can be a front facing sensor and be configured to face towards one or more directions around the computing machine 200. In another embodiment, sensor 230 can be configured to rotate around and/or reposition along one or more axis.

As shown in the present embodiment, the sensor 230 captures a view of any device 280 or an object within the environment of the computing machine 200 by scanning and/or detecting information around the computing machine 200. The sensor 230 can be configured by a processor of the computing machine or by a device application to actively scan the environment for a device 280 or an object. In other embodiments, the sensor 230 can periodically or upon request scan the environment for a device 280 or an object.

As noted above, the device 280 can be or include any component, device, and/or peripheral which can physically or wirelessly couple and communicate with the computing machine 200 and/or any other device coupled to the computing machine 200. As illustrated in FIG. 2, the device 280 can be or include a media device, an image capturing device, an input device, an output device, a storage device, and/or a communication device,

The media device can be or include a music, image, and/or video player. Additionally, the image capturing device can be a camera or any other device which includes an image capturing device. Further, the output device can be a printing device and/or a display device. In addition, the communication device can be a cellular device. In other embodiments, the device 280 can be or include any additional devices in addition to and/or in lieu of those noted above and illustrated in FIG. 2.

As noted above, the device 280 can couple with the computing machine 200 and/or another device. The device 280 can couple with the computing machine 200 and/or another device 280 by physically coupling to a port or an interface of the computing machine 200. In another embodiment, the device 280 can couple with the computing machine 200 and/or another device wirelessly.

In one embodiment, once the device 280 is coupled to the computing machine 200 and/or another recognized device, the device application can proceed to identify the device 280 with the computing machine 200. In other embodiments, the device application can proceed to identify the device before the device 280 has been coupled to the computing machine 200.

As noted above, when identifying the device 280, the device application can access or receive one or more files on the device 280. One or more of the files can include a header file, a device driver file, and/or an identification key. The device application can identify the device 280 by reading one or more of the files to identify a make, a model, and/or a type of the 280. In another embodiment, the device application can identify the device using a file, a list, and/or a database of devices. In other embodiments, the device application can identify the device 280 utilizing additional methods in addition to and/or in lieu of those noted above.

In another embodiment, the sensor 230 can detect one or more objects within a view of the sensor. The sensor 230 can then capture one or more dimensions or any additional information of the object. Utilizing the captured information of the object, the device application can proceed to identify the object as the device 280 and associate the object with the device 280.

Once the device 280 has been identified, the device application can proceed to analyze one or more gestures captured from the sensor 230 and configure the device 280 to communicate with the computing machine 200 and/or another device in response to identifying the device 280 and at least one of the gestures. As noted above, when the device 280 is communicating with the computing machine 200 and/or any other device, a file transfer can be initiated by a device application and one or more instructions or commands can be sent by the device application.

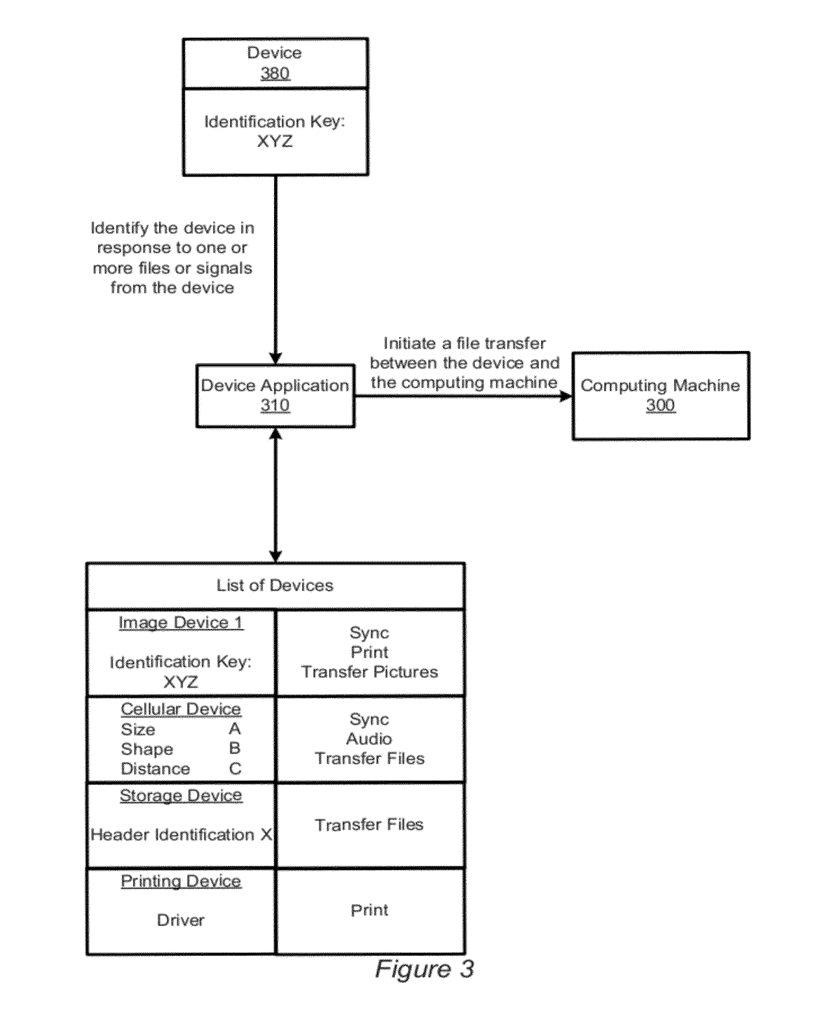

FIG. 3 illustrates a block diagram of a device application 310 identifying a device 380 according to an embodiment of the invention. As noted above, a sensor of a computing machine 300 can be configured by a processor and/or a device application 310 to detect a device 380 found within an environment around the computing machine 300. In one embodiment, the sensor 330 has detected device 380 within the environment around the computing machine 300. In response, the device application 310 proceeds to attempt to identify the device 380.

As noted above, when identifying the device 380, the device application 310 can receive an identification key from the device 380. The identification key can be included as a file on the device 380 or the identification key can be included in a signal transmitted to the device application 310 and/or the computing machine 300. As illustrated in FIG. 3, the device application 310 has received the identification key from the device 380 and identified that the identification key reads XYZ.

As illustrated in FIG. 3, in one embodiment, the device application 310 determines that one or more devices have previously been identified by the device application 310 and/or by the computing machine 300. As shown in the present embodiment, one or more of the identified devices can be included in a list of devices. As shown in FIG. 3, the list of devices can include one or more devices and each of the devices can include a corresponding identification utilized by the device application 310 to identify a device. In other embodiments, one or more of the devices and their corresponding identification can be stored in a file and/or in a database accessible to the device application 310.

As shown in FIG. 3, the identification corresponding to a previously identified device can be an identification key of the device 380. Additionally, the identification corresponding to a previously identified device can be a header file or a device driver file. In another embodiment, the identification corresponding to a previously identified device can include additional information of the device 380, such as the dimensions of the device 380, an image of the device 380, and/or any other information of the device 380.

As shown in the present embodiment, the device application 310 utilizes the identification key from the device 380 and scans the list of devices to determine whether any of the devices list an identification key of XYZ. The device application 310 determines that image device 1 includes an identification key (XYZ) which matches the identification key (XYZ) of the device 380. As a result, the device application 310 proceeds to identify device 380 as Image Device 1.

In another embodiment, if the device application 310 does not find a match in the list of devices, the device application 310 can proceed to read additional information included in an identification key or one or more files on the device 380 to identify a make, a model, and/or a type of the device 380. The device application 310 can then utilize the listed make, model, and/or type of the device to identify the device 380. The device application 310 can additionally edit and/or update the list of recognized devices to include an entry for the identified device 380. Additionally, the device application 310 can store a corresponding identify key or corresponding file utilized to identify the device 380.

Once the device 380 has been identified with the computing machine 300, the device application 310 can proceed to initiate a file transfer with the device 380 and the computing machine 300 and/or another device in response to one or more gestures detected by a sensor when the user is interacting with the device 380.

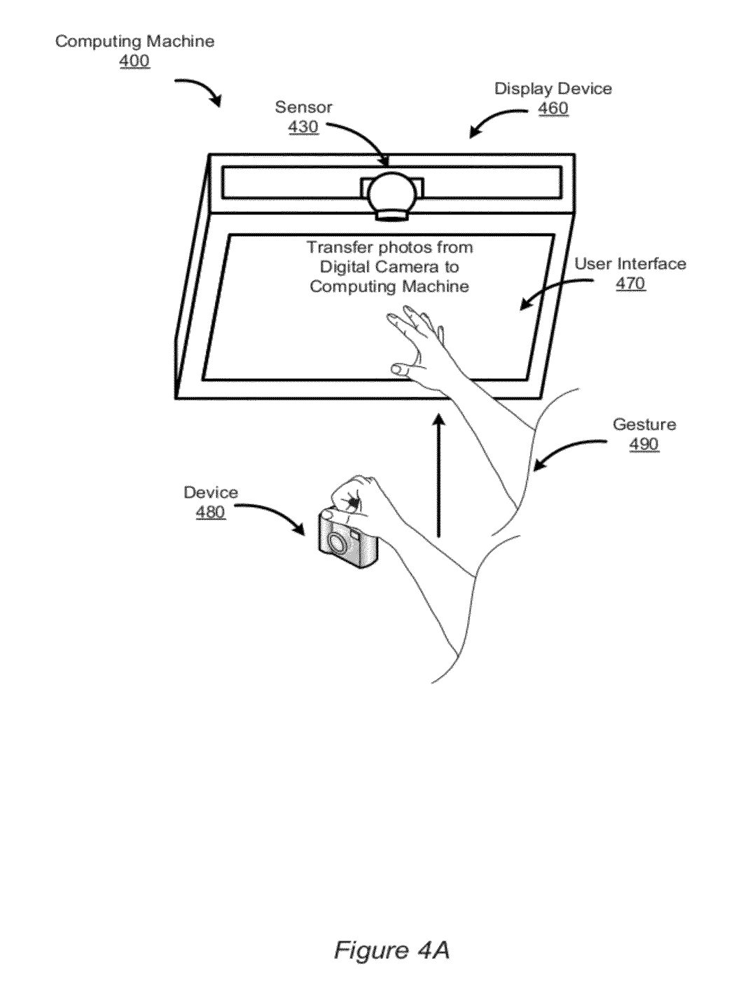

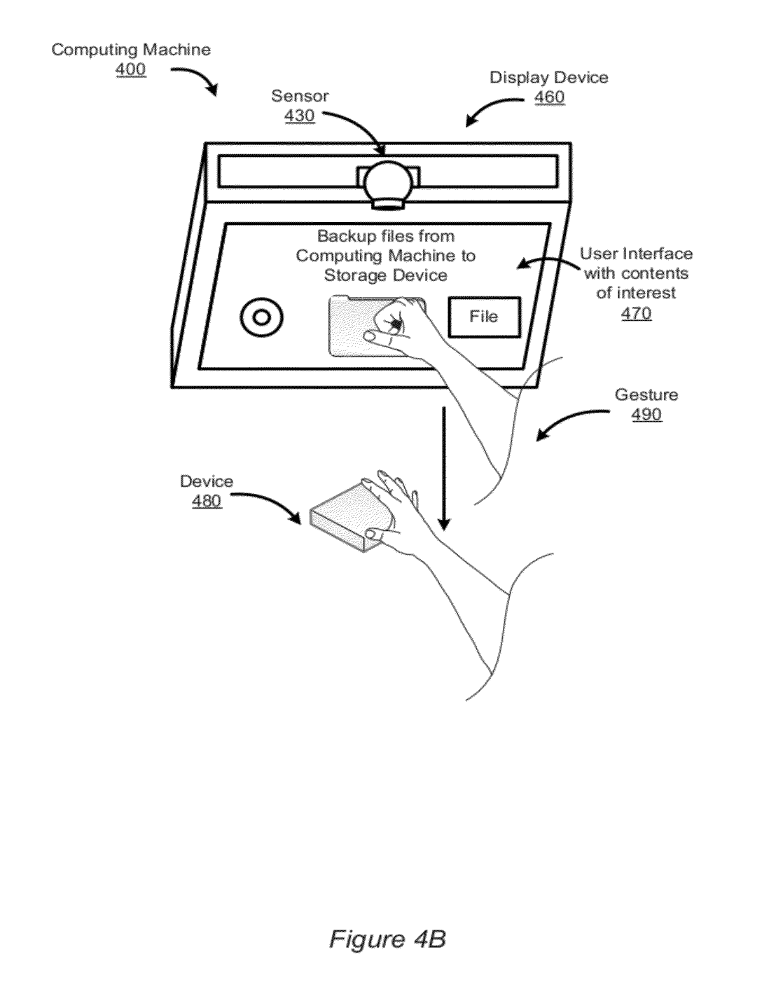

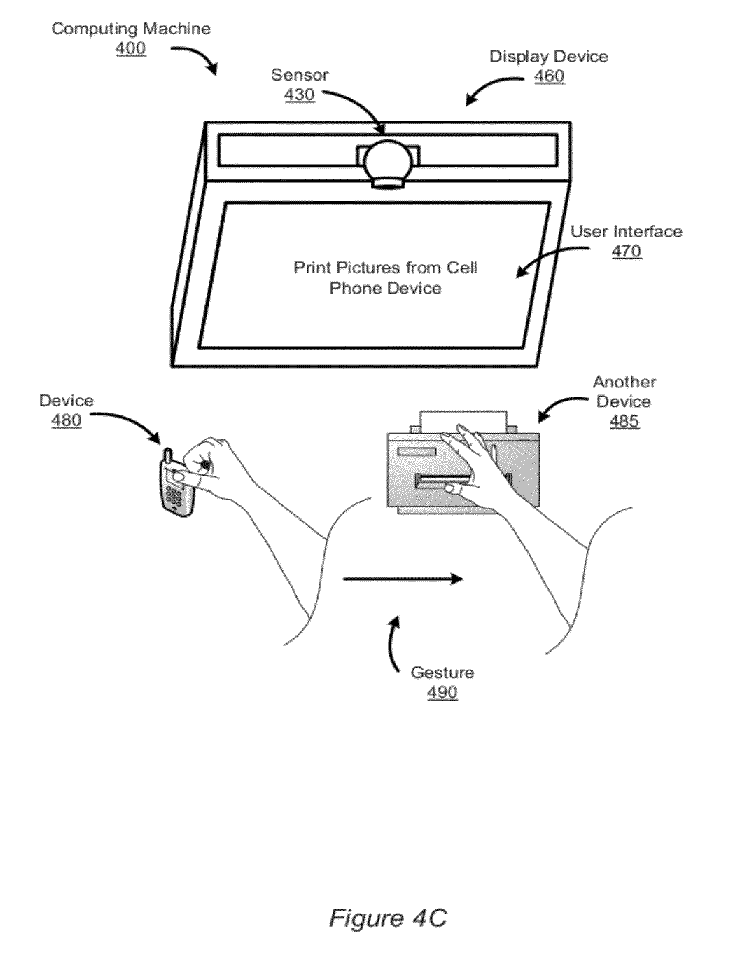

FIG. 4A illustrates a content of interest being identified and a user interacting with a device 480 through at least one gesture according to an embodiment of the invention. In one embodiment, the sensor 430 has detected the device 480 and a device application has identified the device 480 as an image capturing device. Further, the device application has registered the device 480 with the computing machine 480.

As noted above and as illustrated in FIG. 4A, in response to identifying the device 480, the sensor 430 can be configured by a processor and/or the device application to detect and capture information of one or more gestures 490 from a user when the user is interacting with the device 480, the computing machine 400, and/or another device.

Utilizing information captured and identified from one or more gestures, the device application can identify a content of interest to include in a file transfer when the device 480 is communicating with the computing machine 400 and/or another device. Further, the captured information can be utilized by the device application to determine whether the file transfer is to be initiated between the device 480 and the computing machine 400 and/or another device.

As shown in FIG. 4A, the sensor 430 captures the user making a visual gesture 490. As shown in the present embodiment, the visual gesture 490 includes one or more visual gestures in the form of hand motions. The sensor 430 detects that the hand gesture 490 originates over the device 480 and the user's hand is in a closed position. The hand gesture 490 then moves in a direction away from the device 480 and towards a display device 460 coupled to the computing machine 400. The hand gesture 490 then ends when the user releases his hand over the display device 460.

The sensor 430 sends information of the captured hand gesture for the device application 410 to analyze. In one embodiment, the device application 410 determines that the hand gesture 490 originates from the device 480 and ends at the display device 460 of the computing machine 400. As a result, the device application determines that a file transfer should initiate from the device 480 to the computing machine 400.

Further, because the hand gesture originates from the device 480, the device application 480 determines that the content of interest is included in the device 480. As noted above, a content of interest can include one or more files, one or more media, and/or one or more configurations or settings available on the device 480, the computing machine 400 and/or another device.

In one embodiment, a device 480 can have a default content of interest corresponding to all of the files and/or all of the settings on the device 480. In another embodiment, the content of interest can be specified and identified in response to the user accessing the device 480 and/or the computing machine 400.

In the present embodiment, because the device 480 is identified as a image capturing device, the device application determines that the device 480 has a predefined content of interest of all of the images on the device 480. As a result, the device application initiates a communication between the device 480 and the computing machine 400 by configuring the device 480 to transfer one or more image files or photos to the computing machine 400.

Additionally, as illustrated in FIG. 4, the user interface 470 is rendered to display a message on a user interface. As shown in the present embodiment, the message specifies that photos are being transferred from the device 480 to the computing machine 400.

FIG. 4B illustrates a content of interest being identified and a user interacting with a device 480 through at least one gesture according to another embodiment of the invention. In one embodiment, a sensor 430 has detected the device 480 and a device application has identified the device 480 as a storage device.

As noted above, in one embodiment, a display device 460 coupled to the computing machine 400 can be configured to render a user interface 470. As noted above and illustrated in FIG. 4B, the user interface 470 can display one or more content of interest available on the computing machine 400 in the form of one or more icons. One or more of the content of interest can be or include data on a Compact Disc drive of the computing machine 400, one or more files on or accessible to the computing machine 400, and/or one or more folder of files on the computing machine 400 or accessible to a device application.

Further, as shown in FIG. 4B, the sensor 430 has detected a user making a visual hand gesture 490 from the computing machine 400 to the device 480. The sensor 430 detects that the hand gesture 490 originates with the user's hand in a closed position over a display device 460. Further, the sensor 430 detects that the user's hand is position over the folder displayed on the display device 460. As a result, the device application 410 determines that the content of interest is the folder of files rendered on the display device 460.

The user then moves his hand from the display device 460 and releases his hand over the device 480. In response, the device application 410 proceeds to analyze the hand gesture 490 and determines that a file transfer should be initiated from the computing machine 400 to the device 470. In one embodiment, because the device 480 has been identified to be a storage device, the device application determines that the user wishes to backup and/or sync the folder of files with the storage device 480. The device application proceeds to initiate and/or configure the computing machine 400 to initiate a file transfer of the folder of files to the device 480.

FIG. 4C illustrates a content of interest being identified and a user interacting with a device 480 through at least one gesture 490 according to other embodiments of the invention. As noted above, in one embodiment, a file transfer can be initiated between the device 480 and another device 485 coupled to a computing machine 400 in response to at least one gesture 490 from the user.

In one embodiment, a sensor has detected the device 480 and a device application has identified the device 480 to be a cellular device with one or more files. Additionally, another device 485 coupled to the computing machine 400 is identified by the device application as an output device (printing device).

In another embodiment, the device 180 and/or another device 485 can be outside of the view the sensor 430. However, the sensor 430 can detect one or more objects within a view of the sensor 430 and capture dimensions of the objects. Utilizing the captured dimensions of the objects, the device application can scan a file, list, and/or database of identified and/or recognized objects to determine whether any of the devices in the list include dimensions which match the captured dimensions. In one embodiment, the device application determines that a first object has dimensions which match the device 480 and another object has dimensions which match another device 485.

As a result, the device application proceeds to identify one of the objects to be the device 480 and another of the objects to be another device 485. Additionally, the device application configures the sensor 430 to detect any gestures 490 from the user between the objects and corresponds the detected gestures 490 to be gestures made between the device 480 and another device 485.

As illustrated in the present embodiment, the sensor 430 detects the user making a visual hand gesture 490. The hand gesture 490 includes the user's hand in a closed position over the device 480 or the object identified to be the device 480. The user then moves his hand from the device 480 over to another device 485 coupled to the computing machine 400 (or another object identified to be another device 485). The hand gesture 490 ends with the user releasing his hand to an open position over another device 485 (another object identified to be another device 485).

As a result, the device application analyzes the hand gesture 490 and determines that a content of interest is located on the device 480 and should be transferred and/or copied over to another device 485. As a result, the device application sends one or more instructions for the device 480 to initiate a file transfer for the content of interest to be sent to another device 485.

In one embodiment, the content of interest can be transferred from the device 480 to the computing machine 400 and from the computing machine 400 to the other device 485. In another embodiment, the device 480 can be configured to initiate a file transfer of the content of interest directly to the other device 480.

Further, in one embodiment, the device application can further send one or more instructions in response to an identification and/or a type of a device. As illustrated in FIG. 4C, because another device 485 was identified to be a printing device, the device application sends a printing command for the printing device to print the content of interest received from the cellular device 480. In other embodiments, the device application can send additional instructions and/or commands to the device 480, the computing machine 400, and/or another device 485 in response to an identification of the corresponding device or computing machine.

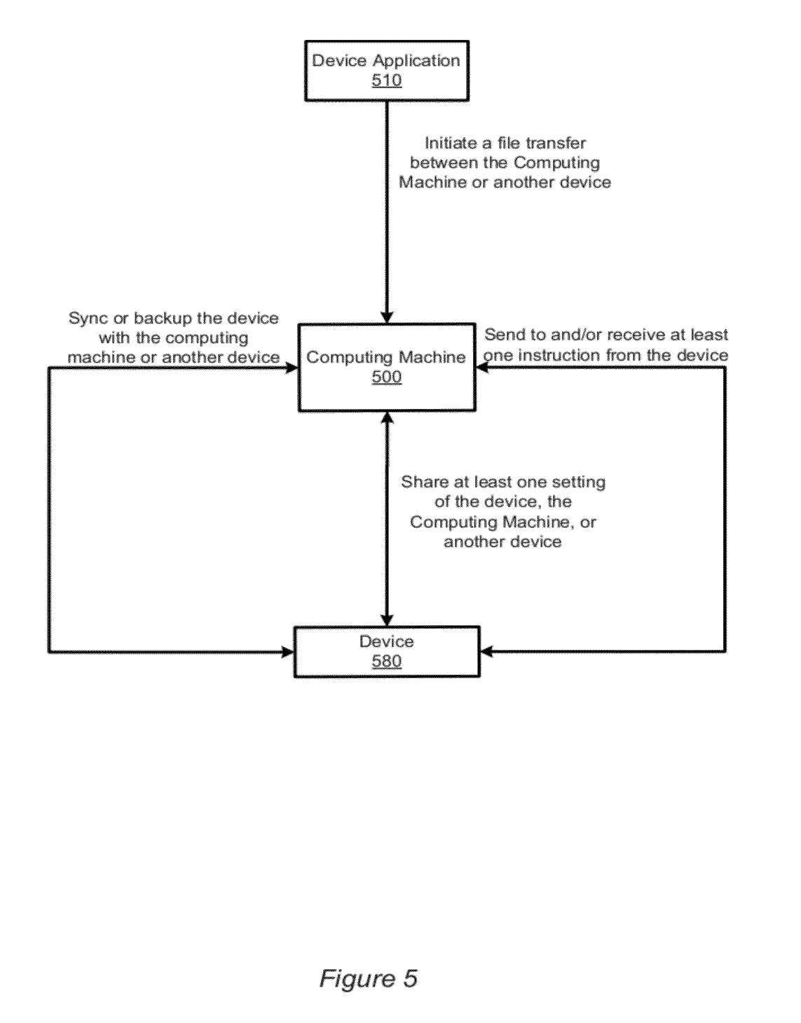

FIG. 5 illustrates a block diagram of a device application 510 initiating a communication between a computing machine 500 and a device 580 according to an embodiment of the invention. As noted above, in response to identifying one or more of gestures from the user when the user is interacting with an identified device, the device application 510 can proceed to initiate a file transfer between the device 580 and the computing machine 500 and/or another device.

As noted above, the file transfer can be utilized by the device 580 and/or the computing machine 500, when syncing or backup one or more files on the device 580, the computing machine 500 and/or another device. Further, the file transfer can be initiated when sharing one or more settings between the device 580, the computing machine 500 and/or another device.

In one embodiment, the device application 510 is further configured to send one or more instructions to the device 580, the computing machine 500, and/or another device. One or more of the instructions and/or commands can be sent in response to an identification and/or a classification of the device 580, the computing machine 500, and/or another device.

One or more of the instructions can specify whether the file transfer is a syncing action and/or a backup action. Further one or more of the instructions can specify whether an action is to be taken with one or more of the transferred files upon completion of the file transfer. In another embodiment, one or more of the instructions can specify whether the files are to be used as configuration settings for the device 580, the computing machine 500, and/or another device.

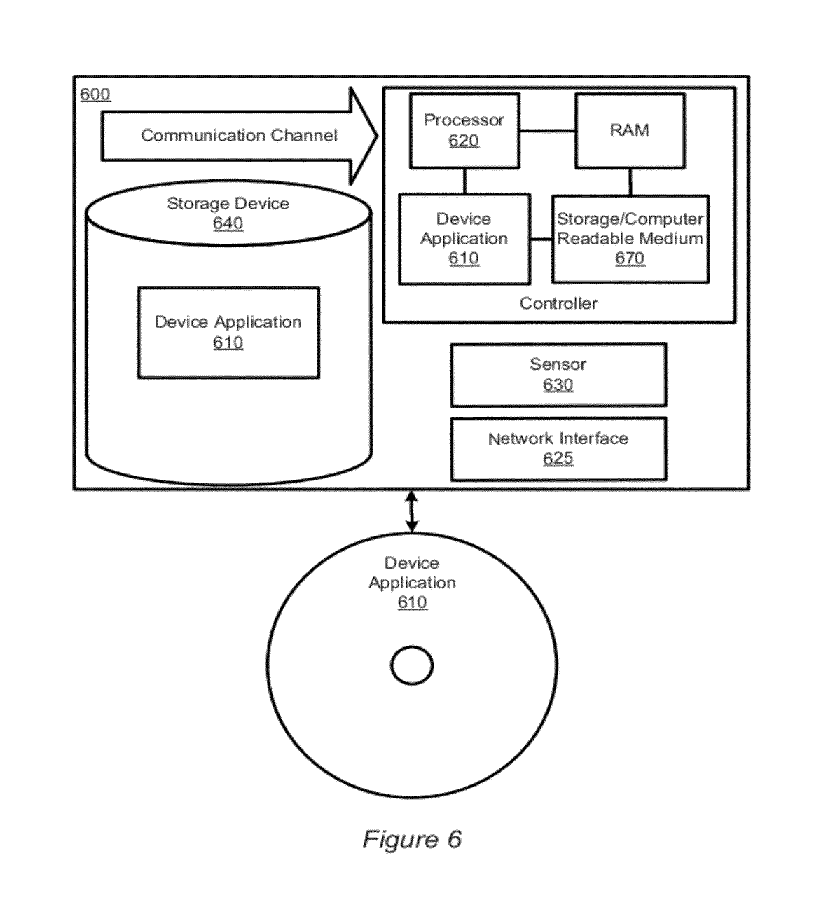

FIG. 6 illustrates a computing machine 600 with an embedded device application 610 and a device application 610 stored on a storage medium 640 being accessed by the computing machine 600 according to an embodiment of the invention. For the purposes of this description, a storage medium 640 is any tangible apparatus that contains, stores, communicates, or transports the device application 610 for use by or in connection with the computing machine 600. As noted above, in one embodiment, the device application 610 is firmware that is embedded into one or more components of the computing machine 600 as ROM. In other embodiments, the device application 610 is a software application which is stored and accessed from a storage medium 640 or any other form of computer readable medium that is coupled to the computing machine 600,

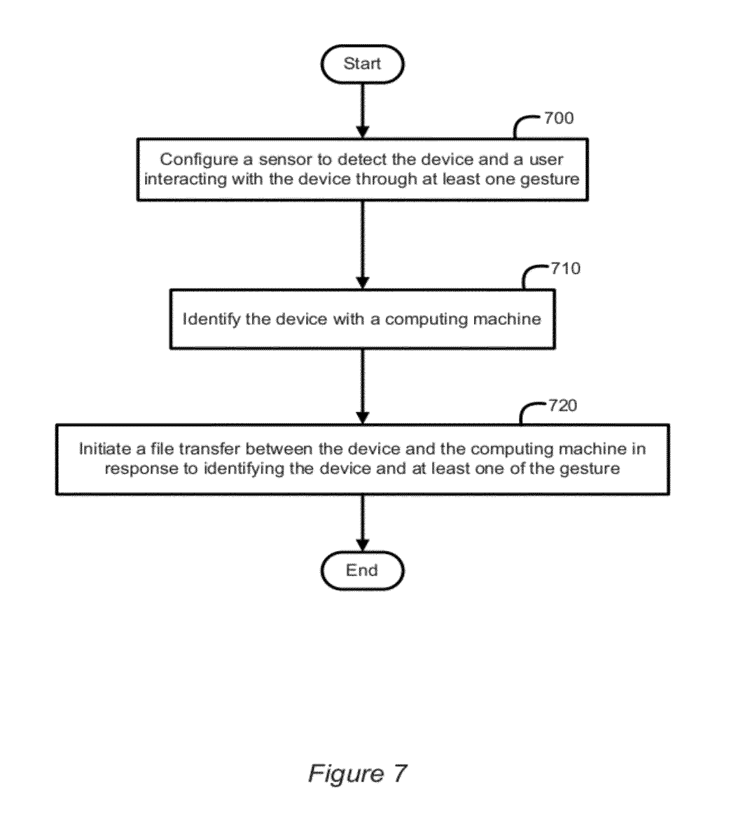

FIG. 7 is a flow chart illustrating a method for communicating with a device according to an embodiment of the invention. The method of FIG. 7 uses a computing machine coupled to a sensor, a processor, a device application, a display device and/or a storage device. In other embodiments, the method of FIG. 7 uses additional components and/or devices in addition to and/or in lieu of those noted above and illustrated in FIGS. 1, 2, 3, 4, 5, and 6.

As noted above, the processor and/or the device application can initially send one or more instructions when configuring the sensor to scan an environment of the computing machine for a device or an object, and to capture a user interacting with the device or the object through at least one gesture 700. As noted above, the device can be any device, computing machine, component, and/or peripheral which can communicate with the computing machine and/or another device in response to a user interacting with the device. Additionally, the object can be any passive object which can be detected by the sensor and identified by the device application to represent the device.

In one embodiment, the sensor is a 3D depth image capture device and the sensor is coupled to a display device of the computing machine. In another embodiment, the sensor can be or include a motion sensor, a proximity sensor, an infrared sensor, a stereo device, and/or any other image capturing device. In other embodiments, a sensor can include additional devices and/or components configured to receive and/or to scan for information from an environment around the sensor or the computing machine.

Once the device or the object have been detected by the sensor, the device application will proceed to identify the device with the computing machine 710. In another embodiment, the device application can proceed to identify a detected object as the device. When identifying the device, the device application can access one or more files on the device. One or more of the files can include a header file and/or a device driver file. Further, one or more of the files can specify a make, a model, and/or a type of the device.

In another embodiment, the device and/or one or more components of the computing machine, such as a network interface, can be configured to broadcast and/or receive one or more wireless signals. One or more of the wireless signals can include one or more of the files and/or an identification key of the device. Further, one or more of the signals and/or the identification key can specify a make, a model, and/or a type of the device.

Utilizing the information from one or more of the files or signals, the device application can proceed to identify the device with the listed make, model, and/or type of the device. In another embodiment, the device application can access a file, a list, and/or a database of devices already identified by the device application and/or the computing machine. The devices can each include a corresponding identification key, a corresponding device driver file, and/or a corresponding header file for the device. Further, the devices in the file, list, and/or database of devices can also list information of the device, such as make, a model, and/or a type of the device.

If the device application finds a matching identification key, device driver file, and/or header file, the device application can proceed to identify the device using the listed make, model, and/or the type of the matching device. If no match is found, the device application can proceed to create a new entry for the device with the listed make, model, and/or type of the device for subsequent identification.

In another embodiment, if the device is not captured within the view of the sensor, the device application can proceed to configure the sensor to capture dimensions and/or information of an object within the view of the sensor. The device application will then compare the captured dimensions and/or information to dimensions and/or information of a device recognized and/or identified by the computing machine. If a match is found, the device application will identify the object as the device.

The device application then proceeds to analyze any gestures detected by the sensor from the user. As noted above, a gesture can include one or more visual motions, one or more audio, and/or one or more touch motions. Further, the sensor can capture a beginning, an end, a length, a duration, a direction, and/or determine whether the gesture is directed at the device, the computing machine, and/or another recognized device.

The sensor can then send information of the captured gesture to the device application. Utilizing information of the captured gesture, the device application can determine that a file transfer is to be initiated. Additionally, the device application can identify a content of interest with the information from the gesture. Further, the device application can whether the file transfer of the content of interest is to be initiated between the device and the computing machine and/or another device.

The device application will then initiate a file transfer between the device and the computing machine and/or another device coupled to the computing machine in response to identifying the device and at least one of the gestures from the user 720. The method is then complete or the device application can continue to initiate one or more file transfers between the device and the computing machine and/or another device in response to identifying the device and the sensor detecting the user interacting with the device. In other embodiments, the method of FIG. 7 includes additional steps in addition to and/or in lieu of those depicted in FIG. 7.

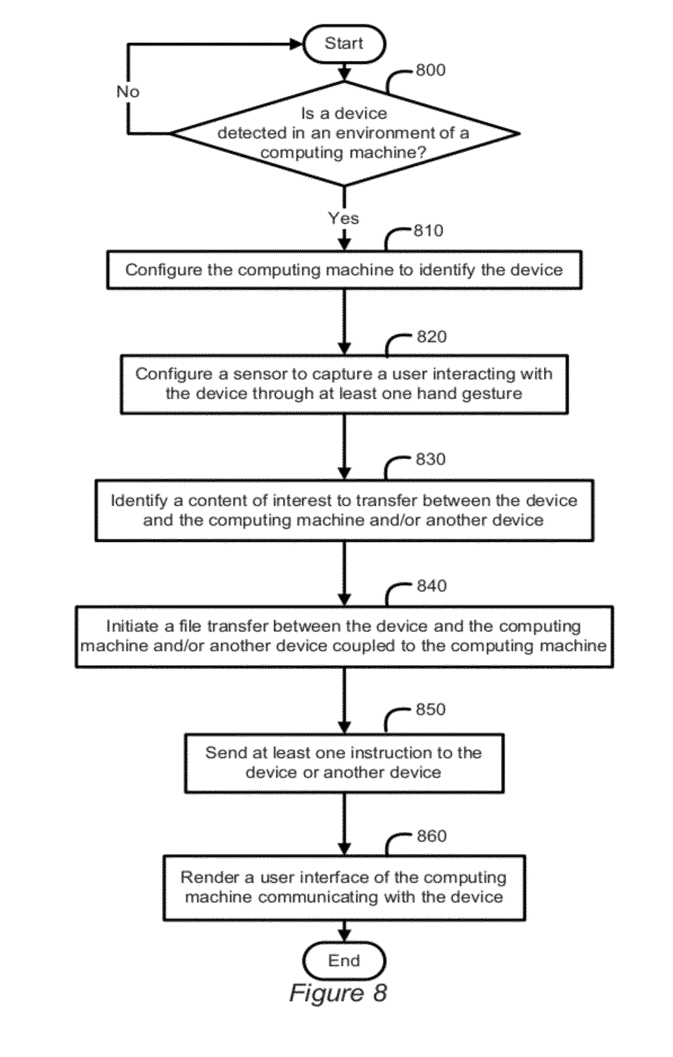

FIG. 8 is a flow chart illustrating a method for communicating with a device according to another embodiment of the invention. Similar to the method disclosed in FIG. 7, the method of FIG. 8 uses a computing machine coupled to a sensor, a processor, a device application, a display device and/or a storage device, In other embodiments, the method of FIG. 8 uses additional components and/or devices in addition to and/or in lieu of those noted above and illustrated in FIGS. 1, 2, 3, 4, 5, and 6.

As noted above, the device application and/or the processor can initially send one or more instructions for the sensor to scan an environment around the computing machine for a device 800. In one embodiment, the sensor is a 3D depth image capture device configured to scan a viewing area and/or a volume around the computing machine for the device or an object which can be identified as a device, In one embodiment, the device is a media device, an input device, an output device, and/or a communication device.

If the sensor detects the device or the object, the device application will attempt to identify the device or represent the object as the device. If the device or the sensor are not detected, the sensor will continue to scan the environment around the computing machine and/or around the sensor for the device or the object 800. As noted above, when identifying the device, the device application proceeds to access one or more files and/or one or more signals from the device. One or more of the files and/or one or more of the signals can be accessed by the device application and/or the computing machine through a physical and/or wireless connection.

In one embodiment, one or more of the files include a header file and/or a device driver file for the device. Further, a signal can include one or more of the files and/or an identification key. One or more of the files and/or the identification key can specify information of the device, such as a make, a model, and/or a type of the device. Utilizing the information read from one or more of the files or signals, the device application can proceed to identify the device 810. In another embodiment, the sensor can capture information of an object and proceed to identify and/or represent the object as the device,

Once the device has been identified or an object has been identified to represent the device, the device application can configure the sensor to detect the user interacting with the device or the representative object through at least one gesture 820. In another embodiment, the sensor is configured to detect the user interacting with the device or the representative object while the device application identifies the device 820. As noted above, when detecting and capturing one or more gestures from the user, the sensor can capture a beginning, an end, a length, a duration, a direction, and/or determine whether the gesture is directed at the device, the computing machine, and/or another recognized device.

Utilizing the information captured from one or more of the gestures, the device application can identify a type of the gesture and identify whether the gesture is made between the device and the computing machine and/or another device. Additionally, the captured information can be utilized to identify a content of interest to transfer between the device and the computing machine and/or another device 830.

As noted above, a content of interest can include one or more files, a folder of files, and/or one or more configuration settings. Further, the content of interest can be displayed as a one or more icons on a user interface rendered as a user interface on a display device.

The content of interest can be defined in response to a user interacting with the user interface through one or more of the gestures. In another embodiment, a device can have a default content of interest based on a type of the device. The default content of interest can be all of the image files on a digital camera. Additionally, the default content of interest can be one or more playlists or media files on a media device, In other embodiments, one or more of the content of interest can include additional files and/or file types in addition to and/or lieu of those noted above.

Once the device application has identified the content of interest and determined whether the file transfer is to be initiated between the device and the computing machine and/or another device, the device application can proceed to initiate the file transfer between the device, the computing machine, and/or another device 840.

In one embodiment, the device application also sends one or more instructions to the device, the computing machine, and/or another recognized device when initiating a file transfer of the content of interest 850. As noted above, one or more of the instructions can be sent in response to an identification and/or a classification of a device and/or the computing machine. In one embodiment, one or more of the instructions can specify whether the file transfer is to be performed as syncing and/or as a backup action.

Additionally, one or more of the instruction can specify whether the device, the computing machine, and/or another device initiates the file transfer. Further, one or more of the instructions can specify any additional actions or instructions to be performed on the content of interest once transferred. In one embodiment, one or more of the instructions specify that the content of interest is to be used as settings to configure the device, the computing machine, and/or another device. In another embodiment, one or more of the instructions can specify that the content of interest is to be printed or outputted.

Further, the device application can configure the display device to render the user interface to display the device communicating with the computing machine and/or another device 860. The method is then complete or the device application can continue to initiate one or more file transfers between the device and the computing machine and/or another device in response to identifying the device and the sensor detecting the user interacting with the device. In other embodiments, the method of FIG. 8 includes additional steps in addition to and/or in lieu of those depicted in FIG. 8.

By configuring a sensor to detect a device in an environment around a computing machine, the device can securely and accurately be identified. Additionally, by configuring the sensor to detect an object and identify the object as a device, an object can be identified and represented as the device when the device is out of a view of the sensor. Further, by initiating a file transfer as a communication between the device and the computing machine and/or another device in response to the user interacting with the device or the representative object through one or more gestures from the user, a user friendly experience can be created for the user while the user interacts with the device or the object.

What is claimed is:

1. A method for communicating with a device comprising:
configuring a sensor to detect the device and a user interacting with the device through at least one gesture;
identifying the device with a computing machine; and
initiating a file transfer between the device and the computing machine in response to identifying the device and at least one of the gesture.

2. The method for communicating with a device of claim 1 further comprising initiating a file transfer between the device and another device couple to the computing machine in response to at least one of the gesture.

3. The method for communicating with a device of claim 1 wherein initiating a file transfer includes at least one from the group consisting of sending at least one file, receiving at least one file, initiating a syncing action, initiating a backup action, and sharing a configuration setting.

4. The method for communicating with a device of claim 1 further comprising identifying a content of interest to transfer between the device and at least one from the group consisting of the computing machine and another device coupled to the computing machine.

5. The method for communicating with a device of claim 1 further comprising sending at least one instruction to at least one from the group consisting of the device, the computing machine, and another device coupled to the computing machine.

6. The method for communicating with a device of claim 1 wherein identifying the device includes configuring the computing machine to read a header file from the device.

7. The method for communicating with a device of claim 1 wherein identifying the device includes configuring the device to share an identification key with the computing machine.

8. A computing machine comprising:
a processor;
at least one sensor configured to scan an environment of the computing machine for a device and a user interacting with the device through at least one gesture;
a device application executed by the processor from a storage medium and configured to identify the device and initiate a file transfer between the device and the computing machine in response to identifying the device and at least one of the gesture.

9. The computing machine of claim 8 wherein the device application is additionally configured to transfer a content of interest between the device and at least one from the group consisting of the computing machine and another device coupled to the computing machine in response to at least one of the gesture.

10. The computing machine of claim 8 further comprising a display device configured to render at least one content of interest for a user to interact with.

11. The computing machine of claim 8 wherein the sensor can be configured to detect an object within the environment of the computing machine and the device application can identify the object as the device.

12. The computing machine of claim 8 wherein the sensor is a 3D depth image capturing device.

13. A computer-readable program in a computer-readable medium comprising:
a device application configured to utilize a sensor to scan an environment of a computing machine for a user interacting with a device;
wherein the device application is additionally configured to identify the device with the computing machine; and
wherein the device application is further configured to initiate a file transfer between the device and the computing machine in response to identifying the device and the user interacting with the device.

14. The computer-readable program in a computer-readable medium of claim 13 wherein the user makes at least one hand gesture between the device and the computing machine when interacting with the device.

15. The computer-readable program in a computer-readable medium of claim 13 wherein the user makes at least one hand gesture between the device and another device when interacting with the device.
